(19) United States
(12) Patent Application Publication
(10) Pub. No.: US 2014/0180486 A1
(43) Pub. Date: Jun. 26, 2014

(54) Multi-Zone Plug-In Load Control Device

(71) Applicant: LUTRON ELECTRONICS CO., INC., Coopersburg, PA (US)

(72) Inventors: Robert C. Newman, JR., Emmaus, PA (US); Joel S. Spira, Coopersburg, PA (US)

(73) Assignee: LUTRON ELECTRONICS CO., INC., Coopersburg, PA (US)

(21) Appl. No.: 13/726,739

(22) Filed: Dec. 26, 2012

(51) Int. Cl. G06F 1/26

(52) U.S. Cl. CPC G06F 1/26
USPC 700/295

(57) ABSTRACT

A multi-zone plug-in load control device controls a plug-in electrical load in a predefined manner in response to received wireless digital messages depending upon which of a plurality of electrical receptacles into which the one of the electrical loads is plugged. The load control device receives wireless digital messages representative of whether the space in which the multi-zone plug-in load control device is located is occupied or vacant from an occupancy sensor. The load control device is operable to determine if one of the electrical loads (e.g., a television) is in a standby mode, and to remove power from the one of the electrical loads in response to determining that the space is vacant only when the one of the electrical loads is in the standby mode. In addition, the load control device is operable to disable further control of the electrical load in response to the received wireless digital messages if an electrical signature of a load current drawn by the one of the electrical loads is similar to a predetermined electrical signature.

### BACKGROUND OF THE INVENTION

1. Field of the Invention

The present invention relates to a load control device for controlling the amount of power delivered to an electrical load, such as a lighting load, and more particularly, to a multi-zone plug-in load control device that is operable to control one or more plug-in electrical loads.

2. Description of the Related Art

Most consumers reduce the total cost of electrical energy by reducing the total energy usages of electrical loads, such as lighting loads. Many consumers are also sensitive to the amount of energy consumed by electrical loads that are turned off, but still consume energy to maintain a standby mode when off. Such electrical loads are often called “vampire” loads. Electrical loads are often controlled in response to occupancy and vacancy sensors, which detect occupancy and/or vacancy conditions in a space, to save energy. Typically, the lighting loads are turned on when the space is occupied and turned off when the space is unoccupied. However, some electrical loads, for example, plug-in loads, such as, personal computers (PCs) or televisions, cannot simply be turned on and off in response to determinations that the space is occupied or vacant. For example, a PC cannot be turned off in response to an occupancy or vacancy sensor since the PC may be executing a critical routine. In addition, it is not desirable to turn a television off when a room is vacated because the user may be have just left for a short period of time and may be returning soon to continue watching the television. Thus, there is a need for a plug-in load control device that is able to automatically turn controlled plug-in electrical loads on and off appropriately in response to occupancy or vacancy sensors without requiring a complex configuration procedure.

### SUMMARY OF THE INVENTION

According to an embodiment of the present invention, a multi-zone plug-in load control device for controlling the power delivered from an AC power source to a plurality of electrical loads comprises a plurality of electrical receptacles adapted to receive respective electrical plugs of the electrical loads, a plurality of load control circuits, a controller, and a radio-frequency (RF) receiver. Each of the load control circuits is coupled to a respective one of the electrical receptacles, and is adapted to be coupled in series electrical connection between the source and the respective one of the electrical loads. The controller is operatively coupled to the load control circuits for controlling the power delivered to the respective loads. The RF receiver is operatively coupled to the controller, such that the controller is operable to receive wireless digital messages representative of whether the space in which the electrical load is located is occupied or vacant. The controller is operable to determine if the space in which the electrical load is located is occupied or vacant in response to the received wireless digital messages. The controller is operable to turn on the electrical loads in response to determining that the space is occupied and to turn off the electrical loads in response to determining that the space is vacant.

According to another embodiment of the present invention, a plug-in load control device for controlling the power delivered from an AC power source to a plug-in electrical load having an electrical plug and located in a space comprises: (1) an electrical receptacle adapted to receive the electrical plug of the electrical load; (2) a load control circuit coupled to the electrical receptacle, such that the load control circuit is adapted to be coupled in series electrical connection between the source and the load; (3) a controller operatively coupled to the load control circuit for controlling the power delivered to the load; and (4) an RF receiver operatively coupled to the controller, such that the controller is operable to receive wireless digital messages and to determine if the space in which the electrical load is located is occupied or vacant in response to the received wireless digital messages. The controller is operable to determine if the electrical load is in a standby mode, and to remove power from the electrical load in response to determining that the space is vacant only when the electrical load is in the standby mode.

In addition, a load control system for controlling the power delivered from an AC power source to a plug-in electrical load having an electrical plug and located in a space is also described herein. The load control system comprises an occupancy sensor operable to determine if the space is occupied or vacant and to transmit digital messages representative of whether the space in which the electrical load is located is occupied or vacant, and a plug-in load control device comprising an electrical receptacle adapted to receive the electrical plug of the electrical load and to control the power delivered to the electrical load. The load control device is operable to receive the digital messages representative of whether the space in which the electrical load is located is occupied or vacant from the occupancy sensor. The load control device is operable to determine if the electrical load is in a standby mode, and to remove power from the electrical load in response to determining that the space is vacant only when the electrical load is in the standby mode.

Other features and advantages of the present invention will become apparent from the following description of the invention that refers to the accompanying drawings.

### BRIEF DESCRIPTION OF THE DRAWINGS

FIG. 1 is a simple diagram of an RF load control system having a multi-zone plug-in load control device, an occupancy sensor, and a remote control according to a first embodiment of the present invention.

FIG. 2 is a simplified block diagram of the plug-in load control device of the RF load control system of FIG. 1.

FIG. 3 is a simplified flowchart of a load current analysis procedure executed by a controller of the plug-in load control device of FIGS. 2.

FIG. 4 is a simplified flowchart of an occupancy message receiving procedure executed by a controller of the plug-in load control device of FIG. 2 when the controller receives a digital message from the occupancy sensor.

FIG. 5 is a simple diagram of an RF load control system having a multi-zone plug-in load control device according to a second embodiment of the present invention.

FIG. 6 is a simplified diagram of a distributed load control system having a multi-zone plug-in load control device according to a third embodiment of the present invention.

### DETAILED DESCRIPTION OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

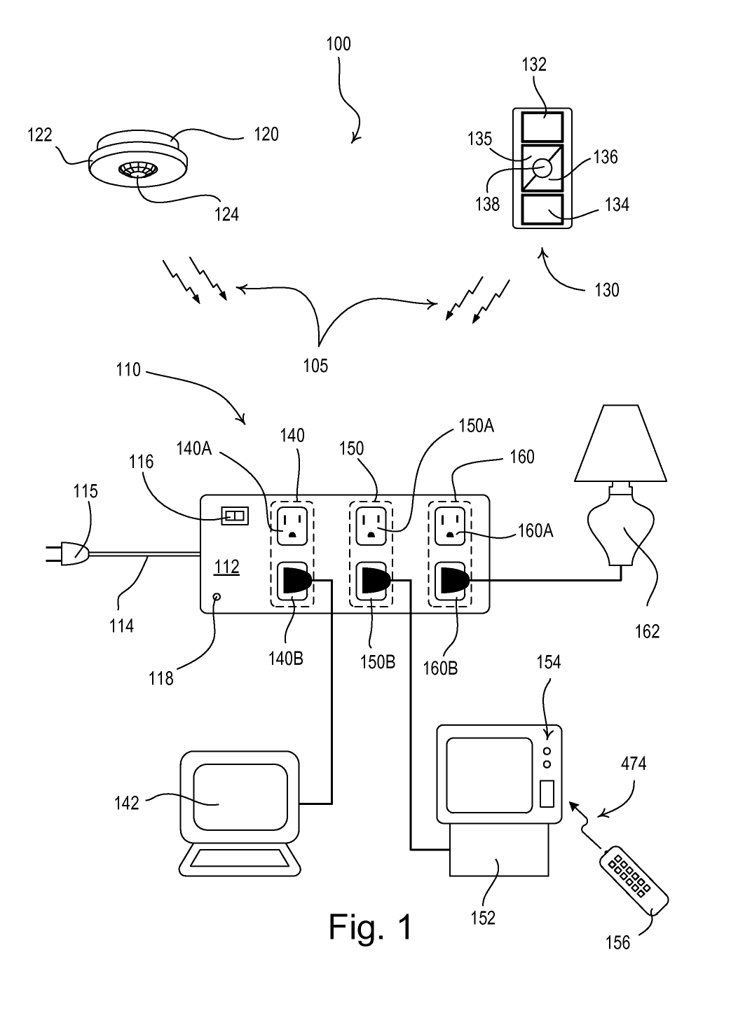

FIG. 1 is a simple diagram of an RF load control system 100 having a multi-zone plug-in load control device 110 (e.g., a power strip or a surge protector), an occupancy sensor 120, and a remote control 130 according to a first embodiment of the present invention. The plug-in load control device 110 comprises an enclosure 112 and an electrical cord 114 having an electrical plug 115 adapted to be plugged into a standard electrical receptacle (not shown) for receiving an AC mains line voltage from an alternating-current (AC) power source (not shown). Alternatively, the plug-in load control device 110 could not comprise the electrical cord 114, and the electrical plug could be mounted directly to the enclosure.

The plug-in load control device 110 also comprises a plurality of electrical receptacles 140A, 140B, 150A, 150B, 160A, 160B for powering one or more electrical loads, such as, for example, a personal computer (PC) 142, a television 152, and a table lamp 162. The electrical receptacles 140A-160B are grouped into three different zones, e.g., a critical zone 140, a vampire-load zone 150, and a dimmed zone 160, for respectively controlling the PC 142, the television 152, and the table lamp 162 in different manners as will be described in greater detail below. The plug-in load control device 110 also comprises a mechanical switch 116 (e.g., a rocker switch) providing manual control of the electrical loads powered by the electrical receptacles 140A-160B by connecting the loads to and disconnecting the loads from the AC power source. In addition, the plug-in load control device 110 comprises a programming button 118 for use during programming of the load control system 100.

The plug-in load control device 110 is operable to control the electrical loads powered by the electrical receptacles 150A-160B connected to the vampire-load zone 150 and the dimmed zone 160 in response to digital messages transmitted wirelessly to the plug-in load control device from the occupancy sensor 120 and the remote control 130 via RF signals 105. During a setup procedure of the RF load control system 100, the occupancy sensor 120 and the remote control 130 are associated with the plug-in load control device 110. For example, a user may actuate the programming button 118 on the plug-in load control device 110 to cause the plug-in load control device to enter an association mode. While the plug-in load control device 110 is in the association mode, the user then actuates an appropriate button on the occupancy sensor 120 or on the remote control 130, such that the occupancy sensor or the remote control transmits a unique identifier (e.g., a serial number) to the plug-in load control device. The plug-in load control device 110 then stores the serial numbers of the occupancy sensor 120 and the remote control 130. Each digital message transmitted by the occupancy sensor 120 or the remote control 130 during normal operation includes the serial number of the transmitting device. The digital messages may also comprise a command for controlling the electrical loads. The plug-in load control device 110 is responsive to messages containing the serial number of the occupancy sensor 120 and the remote control 130 to which the plug-in load control device is assigned.

The remote control 130 transmits digital messages including commands to control the loads connected to the dimmed zone 160 of the plug-in device 110 in response to actuations of one of an on button 132, an off button 134, a raise button 135, a lower button 136, and a preset button 138 of the remote control. The occupancy sensor 120 transmits digital messages to the plug-in load control device 110 in response to detecting an occupancy condition (i.e., the presence of an occupant) or a vacancy condition (i.e., the absence of the occupant) in the vicinity of the plug-in load control device. The occupancy sensor 120 is removably mountable to a ceiling or a wall in the space around the plug-in load control device 110. The occupancy sensor 120 includes an internal detector, e.g., a pyroelectric infrared (PIR) detector, which is housed in an enclosure 122, and is operable to receive infrared energy from the occupant in the space via a lens 124 in the enclosure 122 to thus sense the occupancy condition in the space. The occupancy sensor 120 processes the output of the PIR detector to determine whether an occupancy condition or a vacancy condition is presently occurring in the space, for example, by comparing the output of the PIR detector to a predetermined occupancy voltage threshold. Alternatively, the internal detector could comprise an ultrasonic detector, a microwave detector, or any combination of PIR detectors, ultrasonic detectors, and microwave detectors.

To provide for easy setup and installation, the plug-in load control device 110 automatically controls the electrical loads (i.e., the PC 142, the television 152, and the table lamp 162) in different manners depending upon the zone into which the load is plugged (i.e., the critical zone 140, the vampire-load zone 150, or the dimmed zone 160). The electrical loads plugged into the electrical receptacles 140A, 140B of the critical zone 140 (e.g., computers, routers, modems, and other critical equipment that cannot be turned off) are not controlled in response to the digital messages received from the occupancy sensor 120 and the remote control 130. Thus, the electrical loads plugged into the electrical receptacles 140A, 140B of the critical zone 140 are always powered when the mechanical switch 116 is closed (i.e., conductive) and are unpowered when the mechanical switch is open (i.e., non-conductive).

The electrical loads plugged into the electrical receptacles 150A, 150B of the vampire-load zone 150, e.g., televisions, stereos, and other audio-visual (A/V) equipment, are energized in response to the occupancy sensor 120 detecting that the space is occupied. However, power is removed from the electrical loads plugged into the vampire-load zone 150 only when the electrical loads are in standby mode or are off. For example, if the television 152 is off and the room becomes occupied, the plug-in load control device 110 will connect the television to the AC power source, such that the television may be turned on by local controls 154 or an infrared (IR) remote control 156 of the television. While the television 152 is on (i.e., is not in standby mode), the plug-in load control device 110 does not remove power from the television even if the room becomes unoccupied. In other words, if the television 152 is on, the television is considered to be in use independent of whether the room is occupied or not. For example, perhaps the user is listening to a particular program on the television 152 from another room. When the television 152 is turned off (i.e., is changed to standby mode), the plug-in load control device 110 disconnects the television 152 from the AC power source when the room becomes unoccupied to thus save energy. For example, the plug-in load control device 110 may be operable to determine that the television 152 is on if the magnitude of the current drawn by the television exceeds a predetermined on-current threshold (e.g., approximately 100 milliamps), and to determine that the television is in the standby mode if the magnitude of the current drawn by the television is below the on-current predetermined threshold.

In addition, the plug-in load control device 110 may be operable to determine if the PC 142 is plugged into one of the electrical receptacles 150A, 150B of the vampire-load zone 150 (rather than one of the electrical receptacles 140A, 140B of the critical zone 140) and to disable control of that electrical receptacle in response to the occupancy sensor 120. For example, the plug-in load control device 110 could determine that the PC 142 is plugged into one of the electrical receptacles 150A, 150B of the vampire-load zone 150 by monitoring an electrical signature of the current drawn by the PC. If the electrical signature shows that the PC 142 is plugged into one of the electrical receptacles 150A, 150B of the vampire-load zone 150, the plug-in load control device 110 would power the PC 142 at all times, i.e., would not connect or disconnect power from that electrical receptacle in response to the occupancy sensor 120.

The electrical loads plugged into the electrical receptacles 160A, 160B of the dimmed zone 160 (e.g., lighting loads and other dimmable loads) are controlled in response to both the occupancy sensor 120 and the remote control 130. Specifically, the plug-in load control device 110 provides power to the electrical loads plugged into the electrical receptacles 160A, 160B of the dimmed zone 160 when the occupancy sensor 120 has detected that the space is occupied and does not provide power when the occupancy sensor has detected that the space is vacant. The plug-in load control device 110 is further operable to control the amount of power delivered to the loads connected to the dimmed zone 160 in response to the digital messages transmitted by the remote control 130, for example, to adjust the intensity of lamp 162. Alternatively, the electrical receptacles 160A, 160B of the dimmed zone 160 could simply be controlled to toggle a connected load on and off in response to the occupancy sensor 120 and the remote control 130 (i.e., acting as a switched zone).

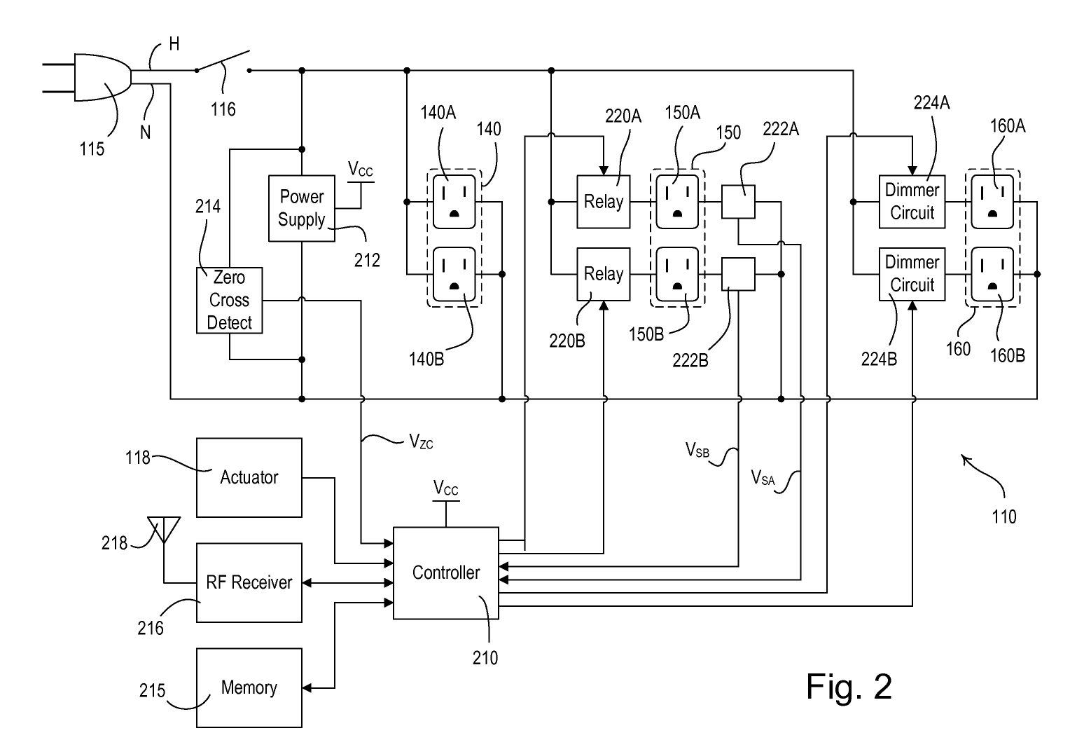

FIG. 2 is a simplified block diagram of the plug-in load control device 110. The electrical cord 114 provides a hot connection H and a neutral connection N to the AC power source for powering the electrical receptacles 140A-160B. The mechanical switch 116 is coupled in series electrical connection between the electrical plug 114 and the electrical receptacles 140A-160B, such that the loads are adapted to be powered when the switch is closed and unpowered when the switch is open. The plug-in load control device 110 comprises a controller 210 for controlling the power delivered to the loads connected to the vampire-load zone 150 and the dimmed zone 160. The controller 210 may be implemented as, for example, a microcontroller, a programmable logic device (PLD), a microprocessor, an application specific integrated circuit (ASIC), a field programmable gate array (FPGA), or any suitable processing device or control circuit.

The plug-in load control device 110 further comprises a power supply 212 coupled between the hot and neutral connections H, N for generating a DC supply voltage V_{CC} (e.g., approximately 5 volts) when the mechanical switch 116 is closed. A zero-cross detect circuit 214 is coupled in parallel with the power supply 212 to receive the AC mains line voltage of the AC power source. The zero-cross detect circuit 214 generates a zero-cross signal V_{ZC}, which is provided to the controller 210 and is representative of the zero-crossings of the input AC main lines voltage of the AC power source. A zero-crossing is defined as the time at which the AC supply voltage transitions from positive to negative polarity, or from negative to positive polarity, at the beginning of each half-cycle.

The controller 210 receives inputs from the programming button 118 during installation of the RF load control system 100. The controller 210 is also coupled to a memory 215 for storage of the serial numbers of the occupancy sensor 120 and the remote control 130 to which the plug-in load control device 110 is assigned. The memory 215 may be implemented as an external integrated circuit (IC) or as an internal circuit of the controller 210. The plug-in load control device 110 further comprises an RF receiver 216 and an antenna 218 for receiving the RF signals 105 from the occupancy sensor 120 and the remote control 130. The controller 210 is operable to control the electrical loads coupled to the electrical receptacles 150A-160B of the vampire-load zone 150 and the dimmed zone 160 in response to the messages received via the RF signals 105. Alternatively, the RF receiver 216 could comprise an RF transceiver for both receiving and transmitting the RF signals 105.

The electrical receptacles 150A, 150B of the vampire-load zone 150 are coupled in series with respective load control circuits, which may comprise controllably conductive devices, such as, for example, relays 220A, 220B. The controller 210 is operable to render the relays 220A, 220B conductive and non-conductive to respectively connect and disconnect the electrical loads of the vampire-load zone 150 to and from the AC power source. The electrical receptacles 150A, 150B of the vampire-load zone 150 are also coupled in series with respective sense circuits 222A, 222B, which generate respective sense signals V_{SA}, V_{SB}. The controller 210 is operable to determine the magnitude of the current drawn by each of the electrical loads connected to the electrical receptacles 150A, 150B of the vampire-load zone 150 in response to the respective sense signals V_{SA}, V_{SB} generated by the sense circuits 222A, 222B. The controller 210 is operable to compare the magnitude of the current being drawn by each load to the predetermined on-current threshold, and to determine that the load connected to the respective electrical receptacle 150A, 150B (e.g., the television 152) is presently on if the magnitude of the current drawn by the load exceeds the predetermined on-current threshold. In addition, the controller 210 may be able to determine the electrical signature of each of the electrical loads connected to the electrical receptacles 150A, 150B of the vampire-load zone 150. The controller 210 may then determine if, for example, the PC 142 is connected to one of the electrical receptacles 150A, 150B if the detected electrical signature is that of a standard PC. Further, the controller 210 could also control the relays 220A, 220B in response to the digital messages transmitted by the remote control 130, for example, to override the control of the electrical receptacles 150A, 150B of the vampire-load zone 150 in response to the occupancy sensor 120.

The electrical receptacles 160A, 160B of the dimmed zone 160 are coupled in series with respective load control circuits, e.g., dimmer circuits 224A, 224B. The controller 210 is operable to control the dimmer circuits 224A, 224B to control the amount of power delivered to the electrical loads powered by the electrical receptacles 160A, 160B of the dimmed zone 160 to thus control the intensity of, for example, the lamp 162. The dimmer circuits 224A, 224B may each comprise a bidirectional semiconductor switch, such as, for example, a triac, a field-effect transistor (FET) in a rectifier bridge, or two FETs in anti-series connection, controlled using a standard phase-control dimming technique. The controller 210 is operable to render the bidirectional semiconductor switch of each of the dimmer circuits 224A, 224B conductive and non-conductive at predetermined times relative to the zero-crossing points of the AC mains lines voltage (i.e., as determined from the zero-cross signal V_{ZC}) using a standard phase-control dimming technique. The controller 210 is operable to control the bidirectional semiconductor switch of each of the dimmer circuits 224A, 224B in response to the digital messages transmitted by both the occupancy sensor 120 and the remote control 130.

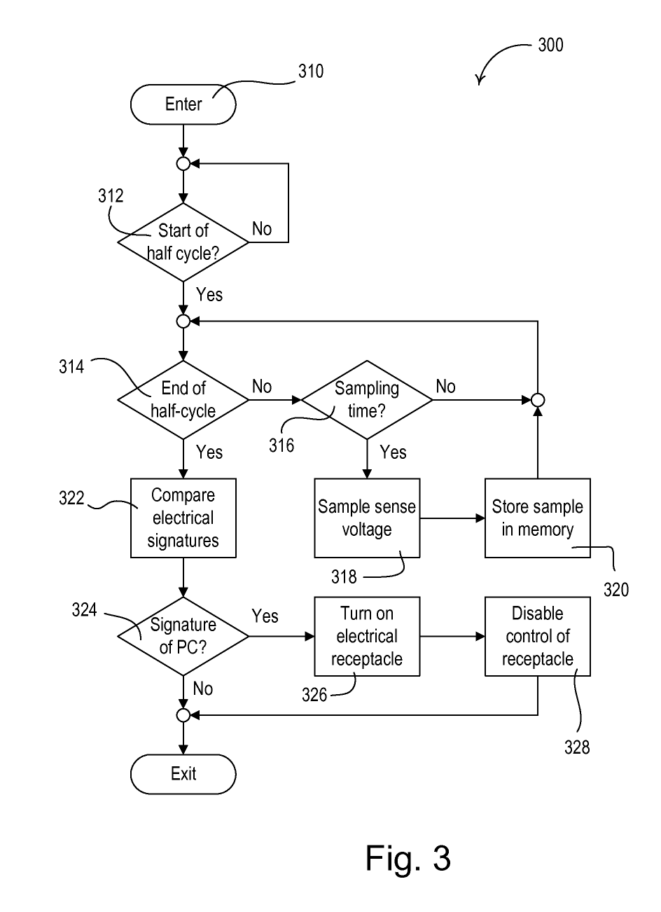

FIG. 3 is a simplified flowchart of a load current analysis procedure 300 executed by the controller 210 of the plug-in load control device 110 when an electrical load is first plugged into one of the electrical receptacles 150A, 150B of the vampire-load zone 150 at step 310. For example, the controller 210 may determine that an electrical load has been plugged into one of the electrical receptacles 150A, 150B of the vampire-load zone 150 by determining that the magnitude of the current drawn through the respective sense circuit 222A, 222B exceeds the predetermined on-current threshold. In addition, the controller 210 may be operable to execute the load current analysis procedure 300 for each of the electrical receptacles 150A, 150B of the vampire-load zone 150 each time that the controller powers up (e.g., resets).

The controller 210 first waits for the beginning of the next half-cycle (i.e., as determined from the zero-cross signal V_{ZC}) at step 312. After the beginning of the next half-cycle, the controller 210 begins to sample the sense signal V_{SA}, V_{SB} of the respective sense circuit 222A, 222B to record and store the electrical signature of the load current of the electrical load. Specifically, if it is not the end of the present half-cycle at step 314, but it is time to sample the respective sense signal V_{SA}, V_{SB} at step 316, the controller 210 samples the sense voltage at step 318 and stores the sample in the memory 215 at step 320. The controller 210 continues to sample the respective sense signal V_{SA}, V_{SB} at the sampling time until the end of the present half-cycle at step 314.

At step 322 after the end of the present half-cycle, the controller 210 compares the electrical signature of the load current of the electrical load that was stored in the memory 215 at step 320 to one or more predetermined electrical signatures that are representative of the electrical signatures of standard personal computers. If the electrical signature of the load current of the electrical load presently plugged into the respective electrical receptacle 150A, 150B of the vampire-load zone 150 is similar to one or more of the predetermined electrical signatures of standard PCs at step 324, the controller 210 turns the respective electrical receptacle on at step 326 and disables further control of the respective electrical receptacle in response to the occupancy sensor 120 at step 328, before the load current analysis procedure 300 exits. If the electrical signature of the load current of the electrical load is not similar to one or more of the predetermined electrical signatures of standard PCs at step 324, the load current analysis procedure 300 simply exits.

In addition, rather than using predetermined electrical signatures representative of the electrical signatures of standard personal computers, the controller 210 could be operable to learn the electrical signature of the PC 142. The controller 210 could be placed in a learning mode (for example, in response to a triple-tap of the programming button 118) and the PC 142 could be temporarily be plugged into the one of the electrical receptacles 150A, 150B of the vampire-load zone 150. The controller 210 could record and store the electrical signature of the PC 142, and then use that stored electrical signature during step 322 of the load current analysis procedure 300. The PC 142 can then be plugged back to the one of the electrical receptacles 140A, 140B of the critical zone 140. Accordingly, if the PC 142 is mistakenly plugged into the electrical receptacles 150A, 150B of the vampire-load zone 150 in the future, the controller 210 will turn the respective electrical receptacle on (at step 326) and disable further control of the respective electrical receptacle in response to the occupancy sensor 120 (at step 328).

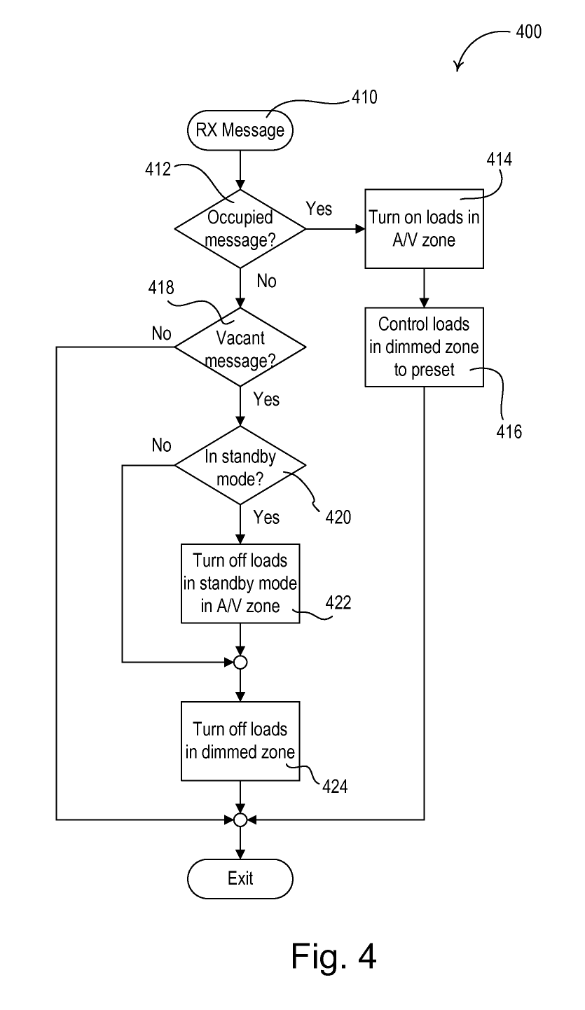

FIG. 4 is a simplified flowchart of an occupancy message receiving procedure 400 executed by the controller 210 of the plug-in load control device 110 when the controller receives a digital message from the occupancy sensor 120 at step 410. The controller 210 does not control the electrical receptacles 150A, 150B of the vampire-load zone 150 that have been disabled during the load current analysis procedure 300 of FIGS. 3.

Referring to FIG. 4, if the received message is an occupied message at step 412, the controller 210 controls the relays 220A, 220B to be conductive to energize the electrical receptacles 150A, 150B of the vampire-load zone 150 at step 414. The controller 210 then controls the dimming circuits 224A, 224B to turn on the electrical loads connected to the electrical receptacles 160A, 160B of the dimmed zone 160 to preset intensities at step 416, before the occupancy message receiving procedure 400 exits. If the received message is not an occupied message at step 412, but is a vacant message at step 418, the controller 210 determines if either of the electrical loads connected to the electrical receptacles 150A, 150B of the vampire-load zone 150 are in the standby mode at step 420 by comparing the magnitude of the currents drawn by the electrical loads to the predetermined on-current threshold. If either of the electrical loads connected to the vampire-load zone 150 are in the standby mode, the controller 210 renders one or both of the relays 220A, 220B non-conductive to disconnect those electrical loads from the AC power source at step 422. Otherwise, the controller 210 keeps the electrical loads that are not in the standby mode (i.e., the loads that are on) powered. Finally, the controller 210 turns off the electrical loads connected to the dimmed zone 160, and the occupancy message receiving procedure 400 exits.

The load control system 100 may also comprise an additional remote control (not shown) having, for example, two buttons, for controlling at least one of the electrical receptacles 150A, 150B of the vampire-load zone 150. For example, the controller 210 may control the relays 220A, 220B to be conductive and non-conductive in response to actuations of the two buttons of the additional remote control to provide manual override (over the control provided by the occupancy sensor 120). In addition, the controller 210 may be operable to enter a bypass mode in which the controller 210 renders the relays 220A, 220B conductive and does not control the relays in response to the occupancy sensor 120. For example, the controller 210 may be operable to enter the bypass mode in response to a double-tap of one of the buttons of the additional remote control.

The load control system 100 could also comprise multiple occupancy sensors 120 that may be spaced apart to detect occupancy conditions in different areas of the vicinity of the lighting load 104. The plug-in load control device 110 could determine that the space is occupied in response to a first occupied command received from any one of the occupancy sensors 120, and to determine that the space is unoccupied in response to the last vacant command received from those occupancy sensors 120 from which the occupancy sensor received either occupied or unoccupied commands. For example, if two occupancy sensors 120 both transmit occupied commands to the dimmer switch 110, the plug-in load control device 110 will not determine that the space is unoccupied until subsequent vacant commands are received from both of the occupancy sensors.

In addition, the occupancy sensors 120 could alternatively be implemented as vacancy sensors. The plug-in load control device 110 would not energize the electrical loads in response to receiving an occupied command from a vacancy sensor. The plug-in load control device 110 would only operate to stop delivering power to the electrical loads when the vacancy sensor detects a vacancy in the space. Therefore, when using vacancy sensors, the table lamp 160 must be turned on manually (e.g., in response to a manual actuation of the on button 132 of the remote control 130). Examples of RF load control systems having occupancy and vacancy sensors are described in greater detail in commonly-assigned U.S. Pat. No. 8,009,042, issued Aug. 30, 2011, entitled RADIO-FREQUENCY LIGHTING CONTROL SYSTEM WITH OCCUPANCY SENSING; U.S. Pat. No. 8,228,184, issued Jul. 24, 2012, entitled BATTERY-POWERED OCCUPANCY SENSOR; and U.S. Pat. No. 8,199,010, issued Jun. 12, 2012, entitled METHOD AND APPARATUS FOR CONFIGURING A WIRELESS SENSOR, the entire disclosures of which are hereby incorporated by reference.

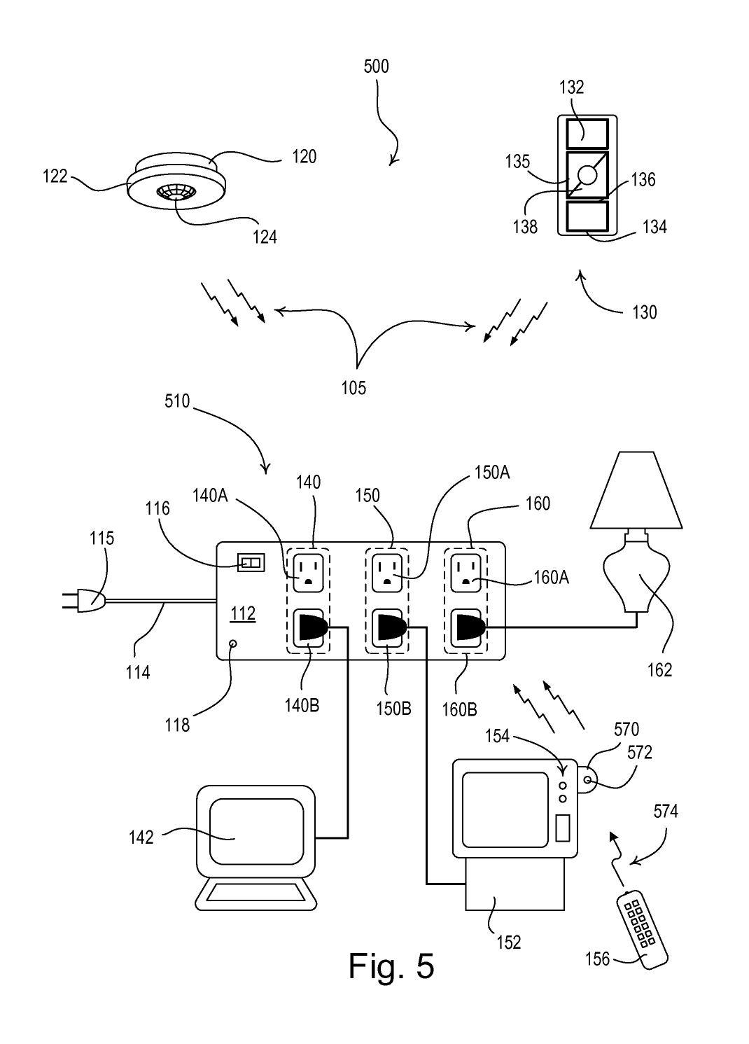

FIG. 5 is a simple diagram of an RF load control system 500 having a multi-zone plug-in load control device 510 according to a second embodiment of the present invention. The RF load control system 500 comprises an infrared (IR) receiving unit 570 mounted on the television 152, for example, next to the IR receiver of the television. The IR receiving unit 570 has an IR receiver 572 for receiving the commands transmitted by the remote control 156 of the television 152 via IR signals 574. The IR receiving unit 570 is then operable to retransmit the received commands to the plug-in load control device 510 via the RF signals 105. Accordingly, the plug-in load control device 510 is operable to operable to determine whether the television 152 is on or in standby mode in response to the commands transmitted by the remote control 156 via the IR signals 574. Thus, the plug-in load control device 510 does not need to measure the magnitude of the current drawn by the television 152 or compare the magnitude of the current drawn by the television to the predetermined on-current threshold in order to determine whether the television is on or in standby mode. As in the first embodiment, the plug-in load control device 510 executes the occupancy message receiving procedure 400 when the plug-in load control device receives a digital message from the occupancy sensor 120. At step 420 of the occupancy message receiving procedure 400, the plug-in load control device 510 of the second embodiment determines if either of the electrical loads connected to the electrical receptacles 150A, 150B of the vampire-load zone 150 are in the standby mode in response to the commands transmitted by the remote control 156 via the IR signals 574 (rather than by comparing the magnitude of the currents drawn by the electrical loads to the predetermined on-current threshold).

Alternatively, television 152 could comprise an Internet-Protocol-enabled television that may be connected to a wireless local area network, such as a WiFi network, for receiving Internet protocol (IP) messages including commands from another Internet-Protocol-enabled remote control device, such as a smart phone (e.g., an iPhone® smart phone, an Android® smart phone, or a Blackberry® smart phone), a personal computer, a laptop, a wireless-capable media device (e.g., MP3 player, gaming device, or television), or a tablet device, (e.g., an iPad® hand-held computing device). The plug-in load control device 510 could also be connected to a wireless local area network for receiving the IP messages from the Internet-Protocol-enabled remote control device. Accordingly, the plug-in load control device 510 could be operable to operable to determine whether the television 152 is on or in standby mode in response to the commands transmitted by the Internet-Protocol-enabled remote control device via the WiFi network.

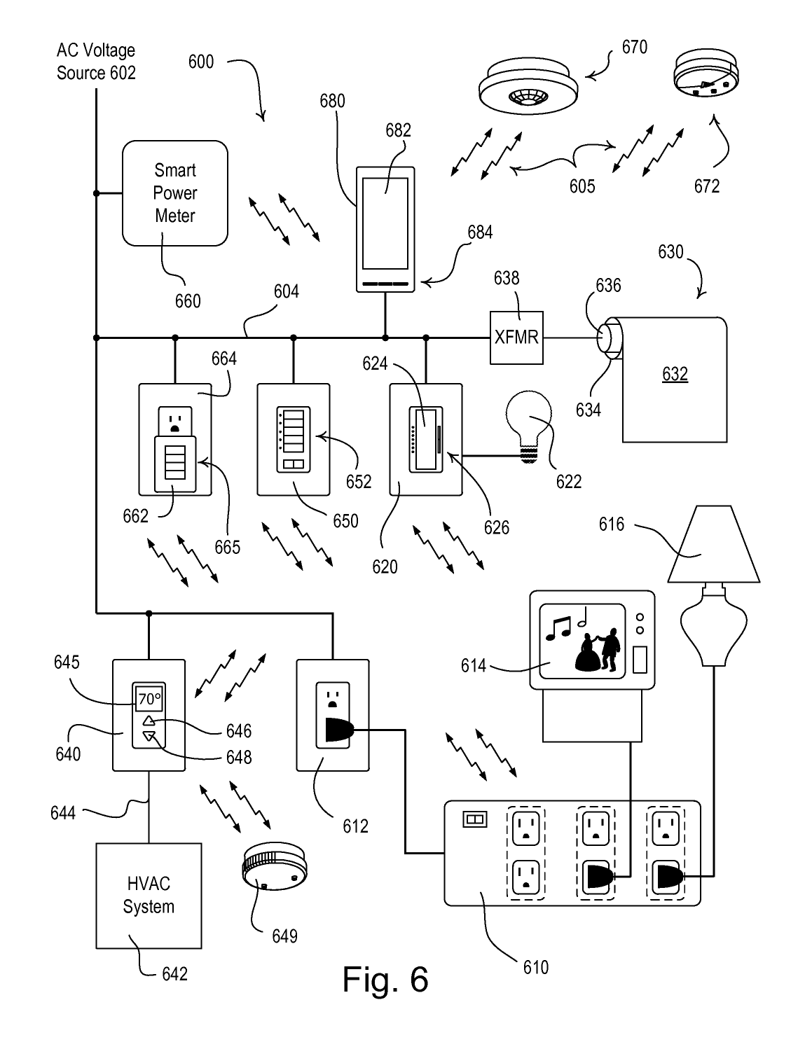

FIG. 6 is a simplified diagram of a distributed load control system 600 having a multi-zone plug-in load control device 610 according to a third embodiment of the present invention. The plug-in load control device 610 is plugged into a standard electrical receptacle 612 and receives power from an AC power source 602 via a line voltage wiring 604. The plug-in load control device 610 of the third embodiment is very similar to the plug-in load control device 110 of the first embodiment. However, the plug-in load control device 610 of the third embodiment comprises an RF transceiver (not shown) for both transmitting and receiving RF signals 605. The plug-in load control device 610 is operable to control the electrical loads plugged into the device (e.g., a television 614 and a table lamp 616) in response to the received RF signals 605 and to transmit status information regarding the controlled electrical loads (e.g., power consumption of the loads) via the RF signals. Examples of two-way RF lighting control systems are described in greater detail in commonly-assigned U.S. Pat. No. 5,905,442, issued on May 18, 1999, entitled METHOD AND APPARATUS FOR CONTROLLING AND DETERMINING THE STATUS OF ELECTRICAL DEVICES FROM REMOTE LOCATIONS, and U.S. patent application Ser. No. 12/033,223, filed Feb. 19, 2008, entitled COMMUNICATION PROTOCOL FOR A RADIO-FREQUENCY LOAD CONTROL SYSTEM, the entire disclosures of which are both hereby incorporated by reference.

The load control system 600 also comprises a wall-mountable dimmer switch 620, which is coupled in series electrical connection between the AC power source 602 and a lighting load 622. The dimmer switch 620 is operable to adjust the amount of power delivered to the lighting load 622 to thus control the present lighting intensity of the lighting load 622. The dimmer switch 620 comprises a control actuator 624 for allowing a user to turn the lighting load 622 on and off. The dimmer switch 620 further comprises an intensity adjustment actuator 626 for allowing the user to adjust the present lighting intensity of the lighting load 622 between a minimum lighting intensity L_{MIN} (e.g., approximately 1%) and a maximum lighting intensity L_{MAX} (e.g., approximately 100%). An example of a wall-mountable dimmer switch is described in greater detail in commonly-assigned U.S. Pat. No. 5,248,919, issued Sep. 29, 1993, entitled LIGHTING CONTROL DEVICE, the entire disclosure of which is hereby incorporated by reference. The dimmer switch 620 is operable to adjust the present lighting intensity of the lighting load 622 in response to the digital messages received via the RF signals 605. The dimmer switch 620 may also transmit feedback information regarding the amount of power being delivered to the lighting load 622 via the digital messages included in the RF signals 605.

The load control system 600 comprises a motorized window treatment, e.g., a motorized roller shade 630, which may be positioned in front of a window for controlling the amount of daylight entering a space. The motorized roller shade 630 comprises a flexible shade fabric 632 rotatably supported by a roller tube 634, and an electronic drive unit (EDU) 636, which may be located inside the roller tube 634. The electronic drive unit 636 may be powered by an external transformer (XFMR) 638, which is coupled to the AC power source 602 and produces a lower voltage AC supply voltage for the electronic drive unit. The electronic drive unit 636 is operable to transmit and receive the RF signals 605, such that the electronic drive unit may control the position of the shade fabric 632 in response to digital messages received via the RF signals and may transmit feedback information regarding the position of the shade fabric via the RF signals.

The load control system 600 also comprises a temperature control device 640, which is coupled to a heating, ventilation, and air-conditioning (HVAC) system 642 via an HVAC communication link 644, e.g., a digital communication link, such as an Ethernet link. The temperature control device 640 is operable to measure a present temperature T_{PRES} in the building and transmit appropriate digital messages to the HVAC system to thus control the present temperature in the building towards a setpoint temperature T_{SET}. The temperature control device 640 may comprise a visual display 645 for displaying the present temperature T_{PRES} in the building or the setpoint temperature T_{SET}, and raise and lower temperature buttons 646, 648 for respectively raising and lowering the setpoint temperature T_{SET} to a desired temperature T_{EES} as specified by the occupant in the building. The temperature control device 640 is also operable to adjust the setpoint temperature T_{SET} in response to digital messages received via the RF signals 605. The temperature control device 640 may be operable to adjust the setpoint temperature T_{SET} in response to the present time of day according to a predetermined timeclock schedule.

The temperature control device 640 is also responsive to RF signals 605 transmitted by a wireless temperature sensor 649, which may be mounted remotely in a location away from the temperature control device and may be battery-powered. The wireless temperature sensor 649 comprises an internal temperature sensing device (not shown) for measuring the present temperature T_{PRES} in the building at the location away from the temperature control device 640. The wireless temperature sensor 649 is operable to transmit digital messages regarding the measured temperature to the temperature control device 640 via the RF signals 605. In response to receiving the RF signals 605 from the wireless temperature sensor 649, the temperature control device 640 is operable to update the visual display 645 to display the present temperature T_{PRES} of the room at the location of the wireless temperature sensor and to control the HVAC system 642, so as to move the present temperature T_{PRES} in the room towards the setpoint temperature T_{SET}.

The load control system 600 may also include a keypad 650 comprising a plurality of preset buttons 652 allowing for manual selection of, for example, energy-savings presets. The keypad 650 transmits digital messages to the other control devices of the load control system 600 via the RF signals 605 in response to actuations of the preset buttons 652. The plug-in load control device 610, the dimmer switch 620, the motorized roller shade 630, and the temperature control device 640 control their associated loads in response to the digital messages transmitted by the keypad 650.

The load control system 600 may also comprise a smart power meter 660 coupled to the line voltage wiring 604. The smart power meter 660 is operable to receive demand response messages or commands from an electrical utility company, for example, via the Internet or via RF signals. The smart power meter 660 may be operable to wirelessly transmit a digital message including the received demand response command to a demand response orchestrating device 662, which may be, for example, plugged into a standard electrical receptacle 664. In response to receiving a digital message from the smart power meter 660 via the RF signals 605 (or other suitable communication means), the demand response orchestrating device 662 is operable to subsequently transmit digital messages including, for example, a demand response preset, via the RF signals 605 to the plug-in load control device 610, the dimmer switch 620, the motorized roller shade 630, and the temperature control device 640.

In response to receiving the demand response preset, the plug-in load control device 610, the dimmer switch 620, the motorized roller shade 630, and the temperature control device 640 are operable to control their associated loads, so as to reduce the total power consumption of the load control system 600. For example, the dimmer switch 620 may reduce the present lighting intensity of the lighting load 622 by a predetermined amount (e.g., approximately 20%) and the electronic drive units 636 may move the respective shade fabrics 632 to the fully-closed position in response to receiving the demand response command to provide thermal insulation such that the HVAC system 642 consumes less power to maintain the setpoint temperature T_{SET}. In response to receiving the demand response command, the temperature control device 640 may increase the setpoint temperature T_{SET} by a first setback temperature T_{SB} (e.g., approximately 2° F.) when the HVAC system 642 is presently in the cooling mode, and may decrease the setpoint temperature T_{SET} by a second setback temperature T_{SB} (e.g., approximately 2° F.) when the HVAC system is presently in the heating mode. In addition, the demand response orchestrating device 662 may comprise one or more buttons 665 for controlling the operation of the load control system 600.

In response to receiving the demand response command, the plug-in load control device 610 may reduce the present lighting intensities of the electrical loads plugged into the dimmable zone 160 (i.e., the table lamp 616) by the predetermined amount (i.e., approximately 20%), and may turn off the electrical loads plugged into the vampire-load zone 150 (i.e., the television 614). A user of the television 614 would then be required to turn the vampire-load zone 150 back on to watch the television, for example, using the two-button remote control described above.

The load control system 600 may further comprise a wireless occupancy sensor 670 for detecting an occupancy condition or a vacancy condition in the space in which the occupancy sensor in mounted. The occupancy sensor 670 is operable to wirelessly transmit digital messages to the plug-in load control device 610, the dimmer switch 620, the motorized roller shade 630, and the temperature control device 640 in response to detecting an occupancy condition or a vacancy condition. The load control system 600 may further comprise a wireless daylight sensor 672 for measuring the ambient light intensity L_{AMB} in the room in which the daylight sensor is mounted. The daylight sensor 672 is operable to wirelessly transmit digital messages to the plug-in load control device 610, the dimmer switch 620, the motorized roller shade 630, and the temperature control device 640 in response to the ambient light intensity L_{AMB} in the space in which the daylight sensor in mounted. Examples of load control systems having daylight sensors are described in greater detail in commonly-assigned U.S. Patent Application Publication No. 2010/0244709, published Sep. 30, 2010, entitled WIRELESS BATTERY-POWERED DAYLIGHT SENSOR, and U.S. Patent Application Publication No. 2010/0244706, published Sep. 30, 2010, entitled METHOD OF CALIBRATING A DAYLIGHT SENSOR, the entire disclosures of which are hereby incorporated by reference.

In addition, the load control system 600 may further comprise a dynamic keypad 680 having a visual display 682. The dynamic keypad 680 is adapted to be mounted to a wall (e.g., in an electrical wallbox), such that the dynamic keypad may be optimally mounted and easily accessible in a space. Alternatively, the dynamic keypad 680 could be surface-mounted to the wall. The dynamic keypad 680 may comprise a touch screen, e.g., a capacitive touch pad, displaced overtop the visual display 682, such that the visual display may display “soft” buttons that may be actuated by a user. Accordingly, the visual display 680 is operable to dynamically change to provide a plurality of different soft buttons to the user to thus allow the user to monitor and adjust many different operating characteristics and parameters of the load control system 600. The dynamic keypad 680 also comprises “hard” buttons 684 (i.e., physical buttons), which may, for example, select predetermined presets or scenes, or turn predetermined loads on and off. Examples of load control systems having dynamic keypads are described in greater detail in commonly-assigned U.S. Patent Application Publication No. 2012/0095601, published Apr. 19, 2012, entitled DYNAMIC KEYPAD FOR CONTROLLING ENERGY-SAVINGS MODES OF A LOAD CONTROL SYSTEM, the entire disclosure of which is hereby incorporated by reference.

The load control system 600 may include other remote control devices, such as, for example, temperature sensors, humidity sensors, pressure sensors, smoke detectors, carbon monoxide detectors, air-quality sensors, radiometers, cloudy-day sensors, security sensors, proximity sensors, fixture sensors, partition sensors, keypads, kinetic or solar-powered remote controls, key fobs, cell phones, smart phones, tablets, personal digital assistants, personal computers, laptops, timeclocks, audio-visual controls, keycard switches, safety devices, and/or power monitoring devices (such as power meters, energy meters, utility submeters, and utility rate meters). In addition, the load control device 600 could comprise a central control transmitter, for example, for transmitting a broadcast command, such as a timeclock command, a load shed command, or a demand response command to the control devices of the load control system. An example of a central control transmitter is described in greater detail in commonly-assigned U.S. patent application Ser. No. 13/725,105, filed Dec. 21, 2012, entitled LOAD CONTROL SYSTEM HAVING INDEPENDENTLY-CONTROLLED UNITS RESPONSIVE TO A BROADCAST CONTROLLER, the entire disclosure of which is hereby incorporated by reference.

Additionally, the load control system 600 could comprise one or more controllable circuit breakers (not shown) for control of other switched electrical loads, such as, for example, a water heater. The load control system 600 may also comprise additional plug-in load control devices 610, dimmer switches 620, motorized roller shades 630, temperature control devices 640, keypads 650, occupancy sensors 670, daylight sensors 672, and dynamic keypads 680. In addition, the load control system could comprise electronic dimming ballasts for driving fluorescent lamps; light-emitting diode (LED) drivers for driving LED light sources (i.e., LED light engines); screw-in luminaires including a integral lighting loads and load control circuits; motor control units for controlling motor loads, such as ceiling fans and exhaust fans; drive units for controlling motorized window treatments or projection screens; motorized interior or exterior shutters; thermostats for heating and/or cooling systems; temperature control devices for controlling heating, ventilation, and air conditioning (HVAC) systems; air conditioners; compressors; electric baseboard heater controllers; controllable dampers; humidity control units; humidifiers; dehumidifiers; boiler controllers; pool pumps; refrigerators; freezers; TVs or computer monitors; video cameras; audio systems or amplifiers; elevators; power supplies; generators; electric chargers, such as electric vehicle chargers; energy storage systems (e.g., a battery, solar, or thermal energy storage systems); and alternative energy controllers (e.g., solar, wind, or thermal energy controllers). Examples of load control systems having a plurality of load control devices that may be controlled in order to decrease the total power consumption of the system are described in greater detail in commonly-assigned U.S. Patent Application Publication No. 2011/0031806, published Feb. 10, 2011, entitled LOAD CONTROL SYSTEM HAVING AN ENERGY SAVINGS MODE, the entire disclosure of which is hereby incorporated by reference.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A multi-zone plug-in load control device for controlling the power delivered from an AC power source to a plurality of electrical loads, the load control device comprising:
a plurality of electrical receptacles adapted to receive respective electrical plugs of the electrical loads;
a plurality of load control circuits, each coupled to a respective one of the electrical receptacles, each load control circuit adapted to be coupled in series electrical connection between the source and the respective one of the electrical loads;
a controller operatively coupled to the load control circuits for controlling the power delivered to the respective loads; and
an RF receiver operatively coupled to the controller, such that the controller is operable to receive wireless digital messages representative of whether the space in which the electrical load is located is occupied or vacant;
wherein the controller is operable to determine if the space in which the electrical load is located is occupied or vacant in response to the received wireless digital messages, the controller operable to turn on the electrical loads in response to determining that the space is occupied and to turn off the electrical loads in response to determining that the space is vacant.

2. The multi-zone plug-in load control device of claim 1, wherein the controller is operable to control one of the electrical loads in a predefined manner in response to the received digital messages depending upon which of the electrical receptacles into which the one of the electrical loads is plugged.

3. The multi-zone plug-in load control device of claim 2, wherein the electrical receptacles are grouped into two or more zones, the controller operable to control the one of the electrical loads in the predefined manner in response to the received digital messages depending upon which of the zones into which the one of the electrical loads is plugged.

4. The multi-zone plug-in load control device of claim 3, wherein the zones comprise a vampire-load zone, the controller operable to determine if an electrical load that is plugged into the vampire-load zone is in a standby mode, the controller operable to remove power from the electrical load that is plugged into the vampire-load zone in response to determining that the space is vacant only when the electrical load is in the standby mode.

5. The multi-zone plug-in load control device of claim 1, wherein the controller is operable to determine if one of the electrical loads is in a standby mode, the controller further operable to remove power from the one of the electrical loads in response to determining that the space is vacant only when the one of the electrical loads is in the standby mode.

6. The multi-zone plug-in load control device of claim 1, wherein the controller is operable to measure and store an electrical signature of the load current drawn by one of the electrical loads, the controller operable to compare the electrical signature to a predetermined electrical signature, and to disable further control of the electrical load in response to the received wireless digital messages if the electrical signature of the load current drawn by the one of the electrical loads is similar to the predetermined electrical signature.

7. A plug-in load control device for controlling the power delivered from an AC power source to a plug-in electrical load having an electrical plug and located in a space, the load control device comprising:
an electrical receptacle adapted to receive the electrical plug of the electrical load;
a load control circuit coupled to the electrical receptacle, such that the load control circuit is adapted to be coupled in series electrical connection between the source and the load;
a controller operatively coupled to the load control circuit for controlling the power delivered to the load; and
an RF receiver operatively coupled to the controller, such that the controller is operable to receive wireless digital messages and to determine if the space in which the electrical load is located is occupied or vacant in response to the received wireless digital messages;
wherein the controller is operable to determine if the electrical load is in a standby mode, the controller operable to remove power from the electrical load in response to determining that the space is vacant only when the electrical load is in the standby mode.

8. The load control device of claim 7, further comprising:
a sense circuit coupled in series with the electrical receptacle and the load control circuit, the controller operatively coupled to the sense circuit, such that the controller is operable to determine a magnitude of a load current drawn by the electrical load;
wherein the controller is operable to determine that the electrical load is in the standby mode if the load current drawn by the electrical load is less than a predetermined threshold.

9. The load control device of claim 8, wherein the controller is operable to measure and store an electrical signature of the load current drawn by the electrical load in response to the sense circuit, the controller operable to compare the electrical signature to a predetermined electrical signature, and to disable further control of the electrical load in response to the received wireless digital messages if the electrical signature of the load current drawn by the electrical load is similar to the predetermined electrical signature.

10. The load control device of claim 7, wherein the electrical load comprises a television adapted to be controlled by an infrared remote control, the controller operable to receive a command transmitted by the infrared remote control from the received wireless digital messages, the controller operable to determine that the electrical load is in the standby mode in response to determining that the command transmitted by the infrared remote control is an off command.

11. The load control device of claim 7, wherein the controller is operable to provide power from the electrical load in response to determining that the space is occupied independent of whether the electrical load is in the standby mode.

12. The load control device of claim 7, further comprising:
a second electrical receptacle adapted to receive the electrical plug of a second electrical load; and
a second load control circuit coupled to the second electrical receptacle, such that the second load control circuit is adapted to be coupled in series electrical connection between the source and the second electrical load;
wherein the controller is operable to control the electrical loads in separate predefined manners in response to the received digital messages depending upon which one of the electrical receptacles into which the respective electrical load is plugged.

13. A load control system for controlling the power delivered from an AC power source to a plug-in electrical load having an electrical plug and located in a space, the load control device comprising:
an occupancy sensor operable to determine if the space is occupied or vacant and to transmit digital messages representative of whether the space in which the electrical load is located is occupied or vacant; and
a plug-in load control device comprising an electrical receptacle adapted to receive the electrical plug of the electrical load and to control the power delivered to the electrical load, the load control device operable to receive the digital messages representative of whether the space in which the electrical load is located is occupied or vacant from the occupancy sensor;
wherein the load control device is operable to determine if the electrical load is in a standby mode, and to remove power from the electrical load in response to determining that the space is vacant only when the electrical load is in the standby mode.

14. The load control system of claim 13, wherein the electrical load is adapted to be controlled by an infrared remote control, the load control device operable to determine that an infrared signal was transmitted by the infrared remote control and to determine that the electrical load is in the standby mode in response to the infrared signal transmitted by the infrared remote control.

15. The load control system of claim 14, further comprising:
an infrared receiving unit comprising an infrared receiver for receiving the infrared signal transmitted by the infrared remote control, the infrared receiving unit operable to wirelessly transmit to the load control device a wireless digital message representative of the infrared signal transmitted by the infrared remote control;
wherein the load control device is operable to determine that the electrical load is in the standby mode in response to the wireless digital message transmitted by the infrared receiving unit.

16. The load control system of claim 14, wherein the electrical load comprises a television having an infrared receiver for receiving the infrared signals from the infrared remote control, the infrared receiving unit adapted to be located next to the infrared receiver of the television.

17. The load control system of claim 14, wherein the infrared signal transmitted by the infrared remote control comprises an off command.

18. The load control system of claim 13, wherein the load control device is operable to determine that the electrical load is in the standby mode if a load current drawn by the electrical load is less than a predetermined threshold.

19. The load control system of claim 18, wherein the load control device is operable to measure and store an electrical signature of a load current drawn by the electrical load, the load control device operable to compare the electrical signature to a predetermined electrical signature, and to disable further control of the electrical load in response to the received digital messages if the electrical signature of the load current drawn by the electrical load is similar to the predetermined electrical signature.

20. The load control system of claim 13, further comprising:
a remote control having an actuator and operable to wirelessly transmit a wireless digital message to the load control device in response to an actuation of the actuator;
wherein the load control device is operable to control the power delivered to the electrical load in response to the wireless digital message received from the remote control.
